(19) United States
(12) Patent Application Publication
(10) Pub. No.: US 2018/0341399 A1
(43) Pub. Date: Nov. 29, 2018

(54) PROBE STATIONS, PROBE SYSTEMS INCLUDING THE PROBE STATIONS, AND METHODS FOR CONTROLLING THE OPERATION OF PROBE STATIONS

(71) Applicant: Cascade Microtech, Inc., Beaverton, OR (US)

(72) Inventors: Jens Fiedler, Dresden (DE); Ralf Keller, Dresden (DE); Jeremy Houston Smith, Beaverton, OR (US)

(21) Appl. No.: 15/986,517

(22) Filed: May 22, 2018

Related U.S. Application Data
(60) Provisional application No. 62/510,127, filed on May 23, 2017.

(51) Int. Cl. G06F 3/0488; H04L 12/26; H04L 12/24

(52) U.S. Cl. CPC G06F 3/04883; G06F 2203/04808; H04L 41/22; H04L 43/12

(57) ABSTRACT

Probe stations, probe systems including probe stations, and methods for controlling the operation of probe stations. In one embodiment, the methods utilize information regarding contact between two of a user's fingers and a touch screen display to change a location of a structure on the touch screen display. In another embodiment, the methods utilize information regarding contact between three of the user's fingers and the touch screen display to transition among different views of the probe stations. In another embodiment, the methods utilize information regarding contact between two fingers on one of the user's hands and the touch screen display and information regarding contact between two fingers on the other of the user's hands and the touch screen display to rotate the image of the probe station. The probe stations include a controller programmed to perform the methods. The probe systems include the probe stations, a server, and mobile device.

### RELATED APPLICATION

This application claims priority to U.S. Provisional Patent Application No. 62/510,127, which was filed on May 23, 2017, and the complete disclosure of which is hereby incorporated by reference.

### FIELD OF THE DISCLOSURE

Probe stations, probe systems including the probe stations, and methods for controlling the operation of probe stations are disclosed herein.

### BACKGROUND OF THE DISCLOSURE

Probe stations may be utilized to test the operation of a device under test (DUT). Conventional probe stations include a chuck, which defines a support surface configured to support a substrate that includes the DUT, and a probe assembly configured to communicate with the DUT. Conventional probe stations also include a user interface, which may include a keyboard, a mouse, and/or a monitor. A user interacts with, or commands, such conventional probe stations via the keyboard and/or the mouse, and the user observes the results of such interaction via the monitor and/or via direct visual observation of the probe station.

While conventional probe stations may be effective in certain circumstances, they may be inefficient in others. In addition, certain users may find it difficult, or inconvenient, to interact with the probe station via conventional means (e.g., utilizing a keyboard, a mouse, and/or a monitor). Thus, there exists a need for improved probe stations, for improved probe systems including the probe stations and/or for improved methods for controlling the operation of probe stations.

### SUMMARY OF THE DISCLOSURE

Probe stations, probe systems including probe stations, and methods for controlling the operation of probe stations. In one embodiment, the methods include displaying a first image of a probe station on a touch screen display, receiving a user input, and displaying a second image of the probe station on the touch screen display. The user input may include information regarding contact between two of a user's fingers and the touch screen display as well as motion of the two fingers across the touch screen display. The first image and the second image both display a structure, and a change in a location of the structure between the two images is based upon the user input.

In another embodiment, the methods include displaying an initial view of the probe station on a touch screen display, receiving a user input, and displaying a subsequent view of the probe station on the touch screen display. The user input includes information regarding contact between three of a user's fingers and the touch screen display as well as motion of the three fingers across the touch screen display. The initial view is collected by an initial imaging device, and the subsequent view is generated by a subsequent imaging device that is different from the initial imaging device.

In another embodiment, the methods include displaying an initial image of the probe station with a touch screen display, receiving a user input, and displaying a rotated image of the probe station. The user input includes information regarding contact between two fingers on a first hand of the user and the touch screen display, information regarding contact between two fingers on a second hand of the user and the touch screen display, and rotational motion of the two fingers on the first hand and of the two fingers on the second hand. A difference between the initial image of the probe station and the rotated image of the probe station is based, at least in part, on the user input.

The probe stations are configured to test the operation of a device under test (DUT) that is formed on a substrate. The probe stations include a chuck with a support surface configured to support the substrate, a probe assembly that includes a plurality of probe tips configured to contact a corresponding plurality of contact pads on the DUT, and a controller programmed to control the operation of the probe station according to the methods.

The probe systems include the probe stations, a server, and mobile device. The server is in communication with the probe station. The mobile device is in communication with the probe station via the server.

### BRIEF DESCRIPTION OF THE DRAWINGS

FIG. 1 is a schematic representation of examples of probe stations and/or of probe systems including the probe stations, according to the present disclosure.

FIG. 2 is a flowchart depicting methods, according to the present disclosure, of controlling the operation of a probe station.

FIG. 3 is an illustration of a portion of the method of FIG. 2.

FIG. 4 is an illustration of a portion of the method of FIG. 2.

FIG. 5 is a flowchart depicting methods, according to the present disclosure, of controlling the operation of a probe station.

FIG. 6 is an illustration of a portion of the method of FIG. 5.

FIG. 7 is an illustration of a portion of the method of FIG. 5.

FIG. 8 is a flowchart depicting methods, according to the present disclosure, of controlling the operation of a probe station.

FIG. 9 is an illustration of a portion of the method of FIG. 8.

FIG. 10 is an illustration of a portion of the method of FIG. 8.

FIG. 11 is a flowchart depicting a method, according to the present disclosure, of controlling the operation of a probe station.

FIG. 12 is an illustration of an example of a gesture that may be utilized with the method of FIG. 11.

FIG. 13 is an illustration of an example of a gesture that may be utilized with the method of FIG. 11.

FIG. 14 is an illustration of an example of a gesture that may be utilized with the method of FIG. 11.

FIG. 15 is an illustration of an example of a gesture that may be utilized with the method of FIG. 11.

FIG. 16 is a flowchart depicting methods, according to the present disclosure, of controlling the operation of a probe station.

### DETAILED DESCRIPTION AND BEST MODE OF THE DISCLOSURE

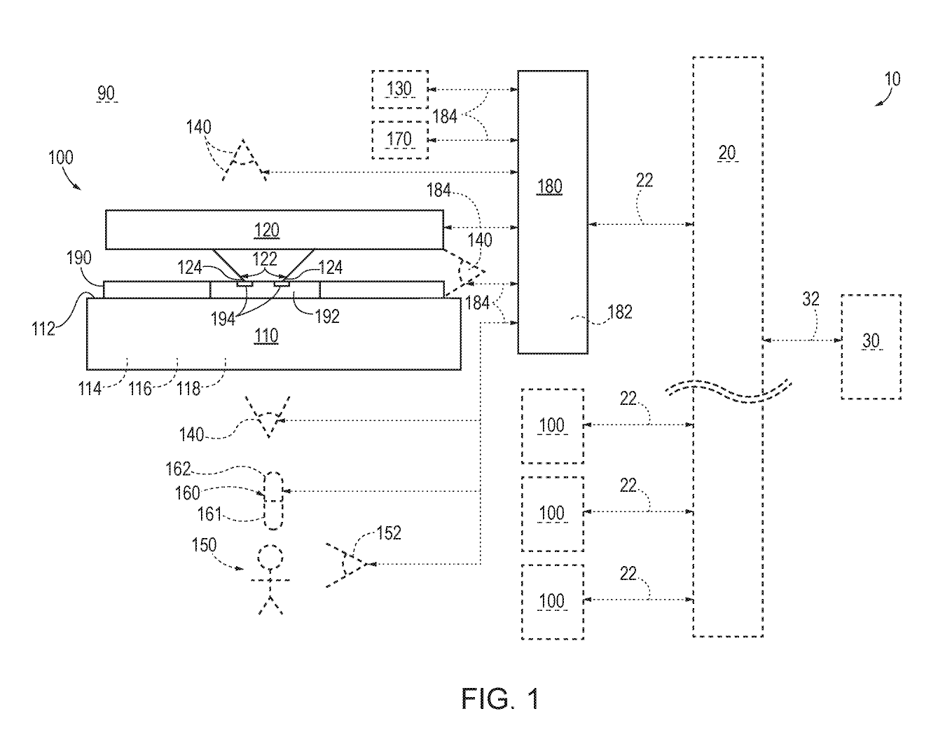

FIGS. 1-16 provide examples of probe stations 100, of probe systems 10 including probe stations 100, and/or of methods 200, 300, 400, 500, and/or 600, according to the present disclosure. Elements that serve a similar, or at least substantially similar, purpose are labeled with like numbers in each of FIGS. 1-16, and these elements may not be discussed in detail herein with reference to each of FIGS. 1-16. Similarly, not all elements may be labeled in each of FIGS. 1-16, but reference numerals associated therewith may be utilized herein for consistency. Elements, components, and/or features that are discussed herein with reference to one or more of FIGS. 1-16 may be included in and/or utilized with any of FIGS. 1-16 without departing from the scope of the present disclosure.

In general, elements that are likely to be included in a particular embodiment are illustrated in solid lines, while elements that are optional are illustrated in dashed lines. However, elements that are shown in solid lines may not be essential to all embodiments and, in some embodiments, may be omitted without departing from the scope of the present disclosure.

FIG. 1 is a schematic representation of examples of probe stations 100 and/or of probe systems 10 including probe stations 100, according to the present disclosure. Probe stations 100 may be configured to test, or electrically test, the operation of a device under test (DUT) 192 that is formed, defined, present, and/or positioned on a substrate 190.

Probe stations 100 include a chuck 110 that defines a support surface 112, which is configured to support substrate 190. Probe stations 100 also include a probe assembly 120 that includes a plurality of probes 122 with a plurality of corresponding probe tips 124. Probe tips 124 are adapted, configured, positioned, and/or oriented to contact a plurality of corresponding contact pads 194 on, in electrical communication with, and/or otherwise associated with DUT 192.

Probe stations 100 also include a controller 180, which is programmed to control the operation of at least a portion of the probe station. This control may be performed via and/or may utilize any suitable communication linkage 184. Communication linkage 184 may permit controller 180 to communicate with at least one other component of probe stations 100 in a wired and/or wireless manner. As examples, controller 180 may communicate with chuck 110, with probe assembly 120, with a touch screen display 130, with one or more imaging devices 140, with a user-imaging device 152, with a microphone 160, and/or with a user input device 170 via communication linkage 184.

Controller 180 may include and/or be any suitable structure, device, and/or devices that may be adapted, configured, designed, constructed, and/or programmed to perform the functions discussed herein. This may include controlling the operation of the at least one other component of probe stations 100, such as via and/or utilizing methods 200, 300, 400, 500, and/or 600, which are discussed in more detail herein. As examples, controller 180 may include one or more of an electronic controller, a dedicated controller, a special-purpose controller, a personal computer, a special-purpose computer, a display device, a touch screen display, a logic device, a memory device, and/or a memory device having computer-readable storage media 182.

The computer-readable storage media, when present, also may be referred to herein as non-transitory computer-readable storage media. This non-transitory computer-readable storage media may include, define, house, and/or store computer-executable instructions, programs, and/or code; and these computer-executable instructions may direct probe station 100 and/or controller 180 thereof to perform any suitable portion, or subset, of methods 200, 300, 400, 500, and/or 600. Examples of such non-transitory computer-readable storage media include CD-ROMs, disks, hard drives, flash memory, etc. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

As illustrated in dashed lines in FIG. 1, probe stations 100 further may include touch screen display 130, which also may be referred to herein as a touch screen 130 and may be configured to permit communication between controller 180 and a user 150 via tactile interaction between the user and the touch screen display. As also illustrated in dashed lines in FIG. 1, probe stations 100 may include imaging device 140, or a plurality of spaced-apart imaging devices 140, which may be configured to view and/or image one or more portions, or regions, of probe station 100. Stated another way, each imaging device 140 may be configured to collect a distinct image of probe station 100. As such, and when probe station 100 includes the plurality of imaging devices 140, the plurality of imaging devices may collect a plurality of distinct, or different, images of the probe station. These distinct images may include images of different components of the probe station, images of the device under test, images of the probe assembly, and/or images of a single structure, such as the device under test and/or the probe assembly, from different angles.

Probe stations 100 also may include user-imaging device 152. User-imaging device 152 may be configured to collect an image of user 150, an image of a gesture of user 150, a plurality of images of the gesture of user 150, and/or a video of the gesture of user 150.

Probe stations 100 further may include a microphone system 160. Microphone system 160 may include a first microphone 161, which may be configured to receive a voice command from user 150. First microphone 161 also may be referred to herein as a user-facing microphone 161, as a microphone 161 that is oriented to receiving an audio command from a user, and/or as a listening device 161 that is configured to listen to the user.

Additionally or alternatively, microphone system 160 may include a second microphone 162, which may be configured to detect ambient noise proximate user 150, such as may be generated within a measurement environment 90 that includes probe station 100. Second microphone 162 also may be referred to herein as an ambient-facing microphone 162, as a microphone 162 that faces away from the user, as a microphone 162 that is oriented to receive ambient noise from the measurement environment, and/or as a listening device 162 that is configured to listen to the ambient environment.

Probe stations 100 also may include one or more other and/or additional input devices, or user input devices, 170. Examples of such user input devices 170 include a keyboard and/or a mouse.

As discussed, support surface 112 of chuck 110 may be configured to support substrate 190. Chuck 110 further may be configured to control a temperature of substrate 190. As an example, chuck 110 may include and/or be a thermal chuck including a chuck thermal module 114 that is configured to control and/or regulate a temperature of the chuck. Chuck thermal module 114 may be in communication with controller 180, such as via communication linkage 184. The controller may control the temperature of substrate 190 utilizing chuck thermal module 114, such as to increase or decrease the temperature of the chuck, to maintain the chuck at a selected temperature, and/or to maintain the chuck within a selected temperature range.

Chuck 110 also may be configured to control and/or regulate a relative orientation between substrate 190 and probe assembly 120 and/or between substrate 190 and one or more imaging devices 140. As an example, chuck 110 may include and/or may be associated with a chuck translation structure 116, which may be in communication with controller 180, such as via communication linkage 184, and/or that may be configured to operatively translate support surface 112 relative to probe assembly 120. As another example, chuck 110 may include and/or be associated with a chuck rotation structure 118, which may be in communication with controller 180, such as via communication linkage 184, and/or that may be configured to operatively rotate support surface 112 relative to probe assembly 120.

As discussed, probe station 100 may be included in and/or may form a portion of probe system 10. In addition to at least one probe station 100, probe system 10 may include a server 20 and/or a mobile device 30. Server 20 may be in communication with one or more probe stations 100 via one or more corresponding communication linkages 22. Mobile device 30 may be in communication with server 20 via a wireless communication linkage 32.

In probe systems 10 that include at least one probe station 100, server 20, and mobile device 30, mobile device 30 may be programmed to communicate with probe stations 100 via server 20. As an example, mobile device 30 may be programmed to transmit, via server 20, a status update request to one or more probe stations. As another example, mobile device 30 may be programmed to receive, via server 20, the status update from the one or more probe stations 100. As yet another example, mobile device 30 may be programmed to receive, via server 20, an error indication from the one or more probe stations 100. As another example, mobile device 30 may be programmed, to transmit, via server 20, a command signal to the one or more probe stations 100.

Mobile device 30 may include and/or be any suitable portable and/or mobile computing device that may be adapted, configured, constructed, and/or programmed for wireless communication with probe stations 100 via server 20. Examples of mobile device 30 include a handheld device, a wireless device, a cellular device, a cellular phone, a smart phone, a tablet, and/or a laptop computer.

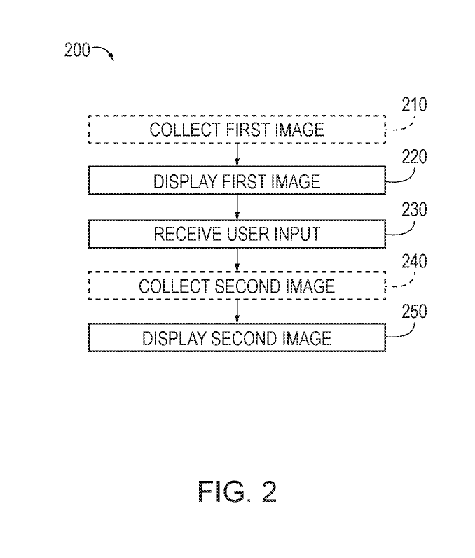

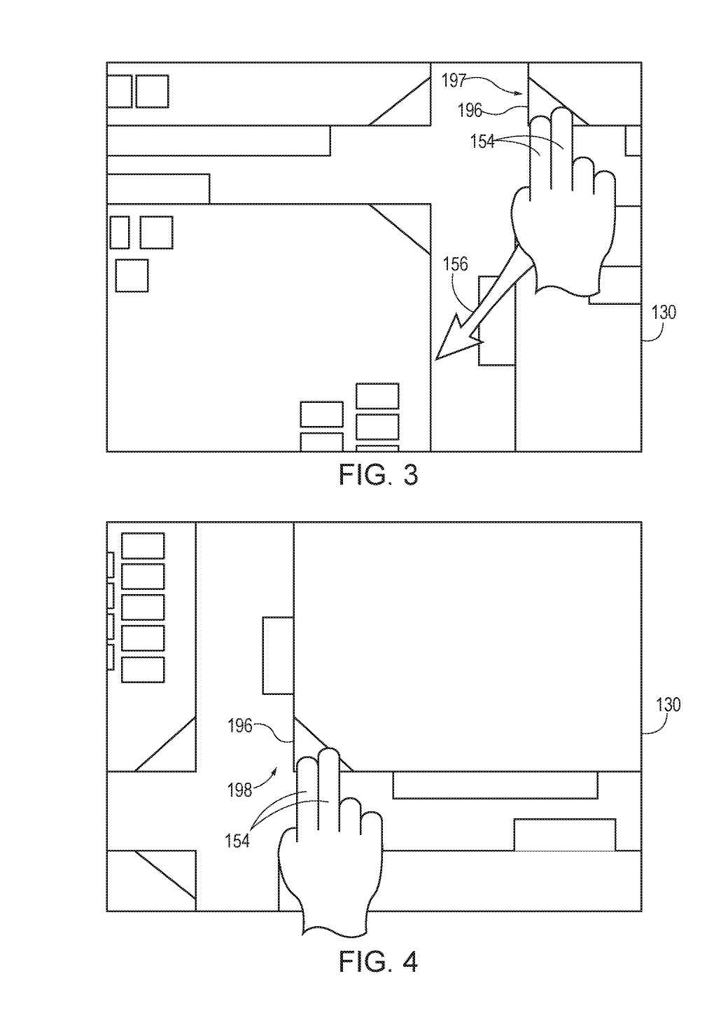

FIG. 2 is a flowchart depicting methods 200, according to the present disclosure, of controlling the operation of a probe station, such as probe station 100 of FIG. 1, while FIGS. 3-4 are illustrations of portions of the method of FIG. 2. The probe station may be configured to test the operation of a device under test (DUT), such as DUT 192 of FIG. 1, that is formed on a substrate, such as substrate 190 of FIG. 1.

Methods 200 may include collecting a first image at 210, and methods 200 include displaying the first image at 220 and receiving a user input at 230. Methods 200 also may include collecting a second image at 240 and include displaying the second image at 250.

Collecting the first image at 210 may include collecting any suitable first image of the probe station in any suitable manner. As an example, the collecting at 210 may include collecting with, via, and/or utilizing an imaging device, such as one or more of the imaging devices 140 that are discussed herein with reference to FIG. 1. Examples of such imaging devices include a camera, a microscope, an optical assembly, a lens, and/or a charge-coupled device.

Displaying the first image at 220 may include displaying the first image with, via, utilizing, and/or on a touch screen display, such as touch screen display 130 of FIG. 1. The touch screen display may include a touch-sensitive, or pressure-sensitive, display surface that is configured to receive tactile instruction from a user, such as during the receiving at 230. An example of the first image is illustrated in FIG. 3.

The first image may include and/or be any suitable image of the probe station. As examples, the first image of the probe station may include, or may include a visual representation of, one or more of at least a portion of the substrate, at least a portion of the DUT, at least one probe tip configured to contact a corresponding contact pad of the DUT, and/or the corresponding contact pad.

Receiving the user input at 230 may include receiving the user input with the touch screen display. Stated another way, the receiving at 230 may include receiving the user input, from a user, with, via, and/or utilizing the touch screen display. This may include receiving information regarding contact, physical contact, or direct contact, between the user and the touch screen display.

More specifically, methods 200 receive a user input in which the user touches, or contacts, the touch screen display with two fingers, or with two fingertips, and moves the two fingers, or two fingertips, across the touch screen display while the two fingers, or the two fingertips, are, or remain, in contact with the touch screen display. This is illustrated in the transition between FIGS. 3-4 by motion of user's fingers 154 across a touch screen display 130, as indicated by arrow 156 in FIG. 3.

With this in mind, methods 200, and more specifically the receiving at 230, may be configured to discriminate, distinguish, or otherwise recognize, contact between the touch screen and two of the user's fingers from contact between the touch screen and fewer or more than two of the user's fingers. As an example, methods 200 may recognize two distinct points of contact with the touch screen that are less than a threshold distance apart as contact between the touch screen and two of the user's fingers and only may respond, such as by proceeding to the collecting at 240, when two of the user's fingers contact, and are moved across, the touch screen.

Collecting the second image at 240 may include collecting any suitable second image of the probe station, which differs from the first image, in any suitable manner. As an example, the collecting at 240 may include collecting with, via, and/or utilizing the imaging device utilized during the collecting at 210.

Displaying the second image at 250 may include displaying a second image of the probe station, which is collected by the imaging device, with the touch screen display and is illustrated in FIG. 4. The second image may be referred to herein as a translated, or re-centered, image of the probe station. With this in mind, a structure, a single structure, and/or the same structure may be displayed in both the first image and the second image. However, a location of the structure, on the touch screen display, may differ between the first image and the second image. This is illustrated in the transition between FIGS. 3 and 4, where a structure 196 is moved from a first location 197, as illustrated in FIG. 3, to a second location 198, as illustrated in FIG. 4.

A transition from the displaying the first image to the displaying the second image may be accomplished in any suitable manner. As an example, methods 200 and/or the displaying at 250 further may include panning from the first image to the second image. As another example, methods 200 and/or the displaying at 250 may include continuously displaying a series of images that illustrate motion of the structure between the first location and the second location. Stated another way, the continuously displaying may include providing live, or real-time, visual feedback to the user regarding the amount of motion of the structure that is generated by motion of the user's fingers on the touch screen display.

A difference in the location of the structure in the second image relative to the first image may be based, at least in part, on the receiving. As an example, a first location of the structure, in the first image, may correspond to, or be, a first contact location between the two of the user's fingers and the touch screen display. Similarly, a second location of the structure, in the second image, may correspond to, or be, a subsequent contact location between the two of the user's fingers and the touch screen display. The subsequent location may be determined after motion of the two of the user's fingers across the touch screen display and/or when the user's fingers separate from the touch screen display.

The difference in the location of the structure between the first image and the second image may be produced, generated, and/or facilitated by changing a relative orientation between the imaging device and at least one other component of the probe station. Examples of the at least one other component of the probe station include a chuck of the probe station, the substrate, the DUT, and/or the one or more probe tips. The changing includes relative motion between the imaging device and the at least one other component of the probe station. As examples, the changing may include moving one or more of the imaging device, the chuck, the substrate, the DUT, and/or the at least one probe tip relative to one or more other of the imaging device, the chuck, the substrate, the DUT, and/or the at least one probe tip. In a specific example, the changing may include moving the chuck, which supports the substrate, thereby moving both the substrate and the DUT, relative to the imaging device; however, this specific configuration is not required of all embodiments.

The change in relative orientation may be based, at least in part, on the receiving at 230. As an example, the receiving at 230 may include determining an initial contact location between the two of the user's fingers and the touch screen display, determining a subsequent contact location between the two of the user's fingers and the touch screen display, and determining a distance between the initial contact location and the subsequent contact location. Under these conditions, the difference between the first location of the structure and the second location of the structure may be based, at least in a part, on the distance between the initial contact location and the subsequent contact location. Additionally or alternatively, a direction, on the touch screen display, from the first location to the second location may be based, at least in part, on a direction between the initial contact location and the subsequent contact location. Additionally or alternatively, a vector that extends, on the touch screen display, from the first contact location to the second contact location may be based, at least in part, on a vector that extends, on the touch screen display, from the initial contact location to the subsequent contact location.

It is within the scope of the present disclosure that the change in relative orientation between the imaging device and the at least one other component of the probe station may include linear, or include only linear, relative motion between the imaging device and the at least one other component of the probe station. As an example, the structure may be a first structure and a second structure also may be displayed in both the first image and the second image. Under these conditions, a difference between a first location of the second structure in the first image and a second location of the second structure in the second image also may be based, at least in part, on the receiving. Additionally or alternatively, a distance between the first location of the second structure and the second location of the second structure may be equal, or at least substantially equal, to a distance between the first location of the first structure and the second location of the first structure.

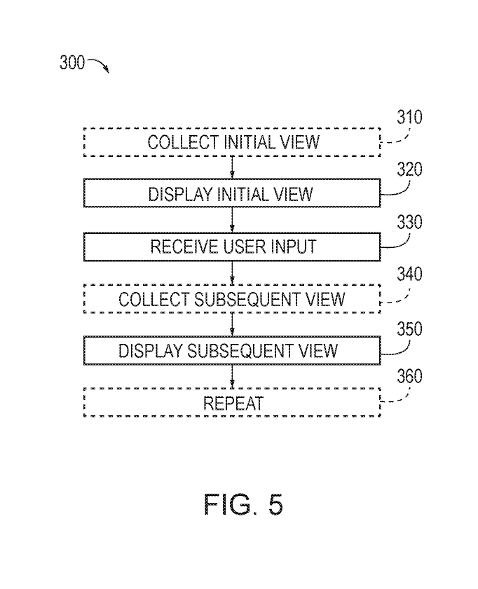

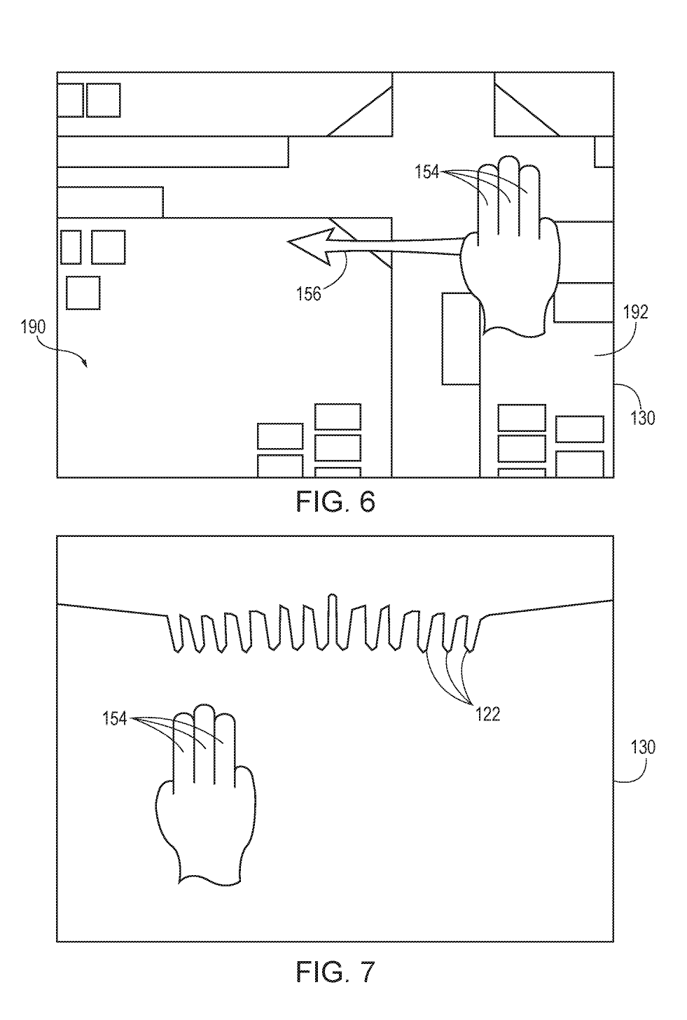

FIG. 5 is a flowchart depicting methods 300, according to the present disclosure, of controlling the operation of a probe station, such as probe station 100 of FIG. 1, while FIGS. 6-7 are illustrations of portions of the method of FIG. 5. The probe station may be configured to test the operation of a device under test (DUT), such as DUT 192 of FIG. 1, that is formed on a substrate, such as substrate 190 of FIG. 1.

Methods 300 may include collecting an initial view of a probe station at 310, and methods 300 include displaying the initial view at 320 and receiving a user input at 330. Methods 300 also may include collecting a subsequent view of the probe station at 340 and include displaying the subsequent view at 350. Methods 300 further may include repeating at least a portion of the methods at 360.

Collecting the initial view of the probe station at 310 may include collecting any suitable initial view of the probe station. This may include collecting the initial view with any suitable initial imaging device. As an example, the collecting at 310 may include collecting with, via, and/or utilizing any of the imaging devices 140 that are illustrated in FIG. 1. Examples of these imaging devices include a downward-looking imaging device configured to collect a downward-looking view of the substrate, a downward-looking imaging device configured to collect a downward-looking view of at least one probe configured to contact a corresponding contact pad of the DUT, a side-looking imaging device configured to collect a side view of the substrate, a side-looking imaging device configured to collect a side view of the at least one probe, an upward-looking imaging device configured to collect an upward-looking view of the substrate, an upward-looking imaging device configured to collect an upward-looking view of the at least one probe, and/or an upward-looking imaging device configured to collect an upward-looking view of a measurement device that is utilized to test the DUT. Examples of the measurement device include a light-collecting sphere and/or a specialized measurement instrument that may be configured to operate cooperatively with the at least one probe.

Displaying the initial view at 320 may include displaying the initial view of the probe station, which is generated by the initial imaging device, on the touch screen display. The initial imaging device and/or the initial view of the probe station may include any of the imaging devices and/or views disclosed herein with reference to the collecting at 310. An example of the initial image, which is a downward-looking view of the substrate collected by a corresponding downward-looking imaging device, is illustrated in FIG. 6.

Receiving the user input at 330 may include receiving the user input with the touch screen display. The user input may include information regarding contact between three of the user's fingers and the touch screen display and motion of three of the user's fingers, while in contact with the touch screen display, across the touch screen display. This is illustrated by motion of user's fingers 154 across touch screen display 130 as indicated by arrow 156 in FIG. 6 and/or as illustrated in the transition in the location of the user's fingers between FIGS. 6 and 7.

Similar to the receiving at 230, the receiving at 330 may be configured to discriminate, or recognize, contact between the touch screen and three of the user's fingers from contact between the touch screen and fewer or more than three of the user's fingers. As an example, methods 300 may recognize three distinct points of contact with the touch screen that are less than a threshold distance apart as contact between the touch screen and three of the user's fingers and only may respond, such as by proceeding to the collecting at 340 and/or to the displaying at 350, when three of the user's fingers contact, and are moved across, the touch screen display.

Collecting the subsequent view of the probe station at 340 may include collecting any suitable subsequent view of the probe station, which differs from the initial view of the probe station, with a subsequent imaging device, which differs from the initial imaging device. Stated another way, the collecting at 340 may utilize a subsequent imaging device that is different, distinct, and/or spaced-apart from the initial imaging device utilized during the collecting at 310 and/or during the displaying at 320.

Displaying the subsequent view at 350 may include displaying any suitable subsequent view of the probe station with the touch screen display. As discussed, the subsequent view of the probe station is different from the initial view of the probe station and is collected by the subsequent imaging device, which is different from the initial imaging device. With this in mind, the displaying at 350 may include displaying any of the views disclosed herein with reference to the collecting at 310. An example of the subsequent image, which is a side-looking view of the at least one probe 122, is illustrated in FIG. 7.

It is within the scope of the present disclosure that the displaying at 350 may be responsive to the receiving at 330 meeting a predetermined and/or established threshold and/or criteria. As an example, the touch screen display may have and/or define a characteristic dimension, such as a characteristic height and/or width. Under these conditions, the displaying at 350 may be responsive to the user input, which is received during the receiving at 330, including information regarding motion of the three of the user's fingers across at least a threshold fraction of the characteristic dimension. Examples of the threshold fraction of the characteristic dimension include at least 10%, at least 20%, at least 30%, at least 40%, at least 50%, at least 60%, at least 70%, at least 80%, at least 90%, at most 99%, at most 95%, at most 90%, at most 80%, at most 70%, and/or at most 60% of the characteristic dimension.

Repeating at least the portion of the methods at 360 may include repeating any suitable portion of methods 300 in any suitable manner. As an example, the repeating at 360 may include repeating the receiving at 330 and, responsive to the repeating the receiving at 330, repeating the displaying at 350 to display a different view of the probe station that is collected by a different imaging device. Stated another way, the repeating at 360 may include transitioning through a plurality of available views of the probe station, collected by a corresponding plurality of imaging devices. This may include advancing, or sequentially advancing, from a given view in the plurality of views to a next, or subsequent, view in the plurality of views responsive to each repeated instance of the receiving at 330.

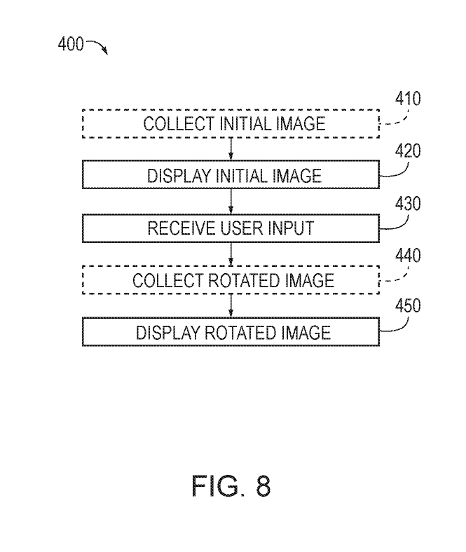

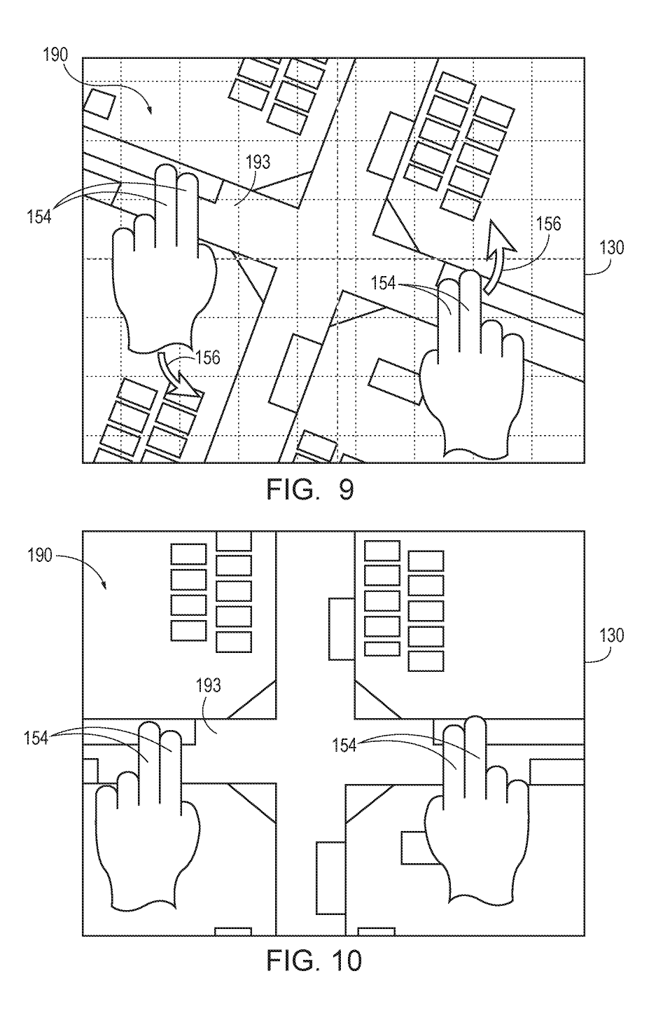

FIG. 8 is a flowchart depicting methods 400, according to the present disclosure, of controlling the operation of a probe station, such as probe station 100 of FIG. 1, while FIGS. 9-10 are illustrations of portions of the method of FIG. 8. The probe station may be configured to test the operation of a device under test (DUT), such as DUT 192 of FIG. 1, that is formed on a substrate, such as substrate 190 of FIG. 1.

Methods 400 may include collecting an initial image at 410, and methods 400 include displaying the initial image at 420 and receiving a user input at 430. Methods 400 also may include collecting a rotated image at 440 and include displaying the rotated image at 450.

Collecting the initial image at 410 may include collecting any suitable initial image of the probe station. This may include collecting the initial image with any suitable imaging device. As an example, the collecting at 410 may include collecting with, via, and/or utilizing any of the imaging devices 140 that are illustrated in FIG. 1. Examples of the initial image of the probe station include an image that includes at least a portion of the substrate, at least a portion of the DUT, and/or at least one probe tip configured to contact a corresponding contact pad of the DUT. An example of the initial image is illustrated in FIG. 9.

Displaying the initial image at 420 may include displaying any suitable initial image of the probe station with a touch screen display. The initial image may include any suitable image of the probe station, such as those disclosed herein with reference to the collecting at 410. As an example, and as illustrated in FIG. 9, the initial image may include an image of the portion of the substrate.

Receiving the user input at 430 may include receiving the user input from the user with the touch screen display. The user input may include information regarding contact between two fingers on a first, or left, hand of the user and the touch screen display. The user input also may include information regarding contact between two fingers on a second, or right, hand of the user and the touch screen display. The user input further may include information regarding relative rotational motion, while in contact with the touch screen display, between the two fingers on the first hand and the two fingers on the second hand. This may include rotational motion of the two fingers on the first hand relative to the two fingers on the second hand, relative motion of the two fingers on the second hand relative to the two fingers on the first hand, and/or motion of the two fingers on the first hand and the two fingers on the second hand relative to one another.

As an example, and as illustrated in FIG. 9, the user may contact touch screen 130 with two fingers 154 from each hand. Subsequently, and as illustrated by arrows 156 in FIG. 9 and in the transition from FIG. 9 to FIG. 10, the user's fingers may be rotated.

Collecting the rotated image at 440 may include collecting the rotated image of the probe station with the imaging device. The rotated image of the probe station may include, or be, a rotated view of the initial image of the probe station that was collected during the collecting at 410 and/or that was displayed during the displaying at 420.

Displaying the rotated image at 450 may include displaying any suitable rotated image of the probe station that is a rotated view of the initial image of the probe station. A difference between the initial image of the probe station and the rotated image of the probe station may be based, at least in part, on the receiving at 430. Stated another way, the displaying at 450 may include rotating the initial image of the probe station about an axis of rotation to produce and/or generate the rotated image of the probe station. An example of the rotated image of the probe station is illustrated in FIG. 10.

It is within the scope of the present disclosure that the displaying at 450 may include displaying a virtual, or computer-generated, rotated image, such as may be generated by electronically rotating the initial image to produce and/or generate the rotated image. Additionally or alternatively, it also is within the scope of the present disclosure that the displaying at 450 may include changing a relative orientation between the imaging device and at least one other component of the probe station to produce and/or generate the rotated image of the probe station.

As examples, the changing the relative orientation may include rotating the imaging device relative to the substrate and/or rotating the substrate relative to the imaging device. As a more specific example, the probe station may include a chuck that defines a support surface configured to support the substrate. Under these conditions, the changing the relative orientation may include rotating the chuck relative to the imaging device, thereby rotating the substrate and/or the DUT relative to the imaging device.

The changing the relative orientation may include changing the relative orientation to align a structure on the substrate with, or within, the touch screen display. This is illustrated by the transition from FIG. 9 to FIG. 10. As illustrated therein, the user may touch, or contact, on touch screen display 130, opposed sides of an elongate structure, such as a scribe line 193 between adjacent die, with two fingers 154 from each hand. Subsequently, the user may rotate the two fingers from one hand and the two fingers from the other hand, relative to one another, to align the elongate structure on the touch screen display.

Additionally or alternatively, the changing the relative orientation may include rotationally aligning a plurality of probes of the probe station with a plurality of corresponding contact pads of the DUT. Under these conditions, the changing the relative orientation may include operatively rotating one of the substrate and the plurality of probes relative to the other of the substrate and the plurality of probes.

It is within the scope of the present disclosure that, subsequent to the displaying the initial image, prior to the displaying the rotated image, and/or concurrently with the receiving the user input, methods 400 may include displaying a plurality of intermediate images. The plurality of intermediate images may illustrate a transition from the initial image to the rotated image. The displaying the plurality of intermediate images may be synchronous with, or may track, motion of the user's fingers during the receiving the user input. Stated another way, the displaying the plurality of intermediate images may include providing live, or real-time, visual feedback to the user regarding the amount of rotation generated by motion of the user's fingers on the touch screen display.

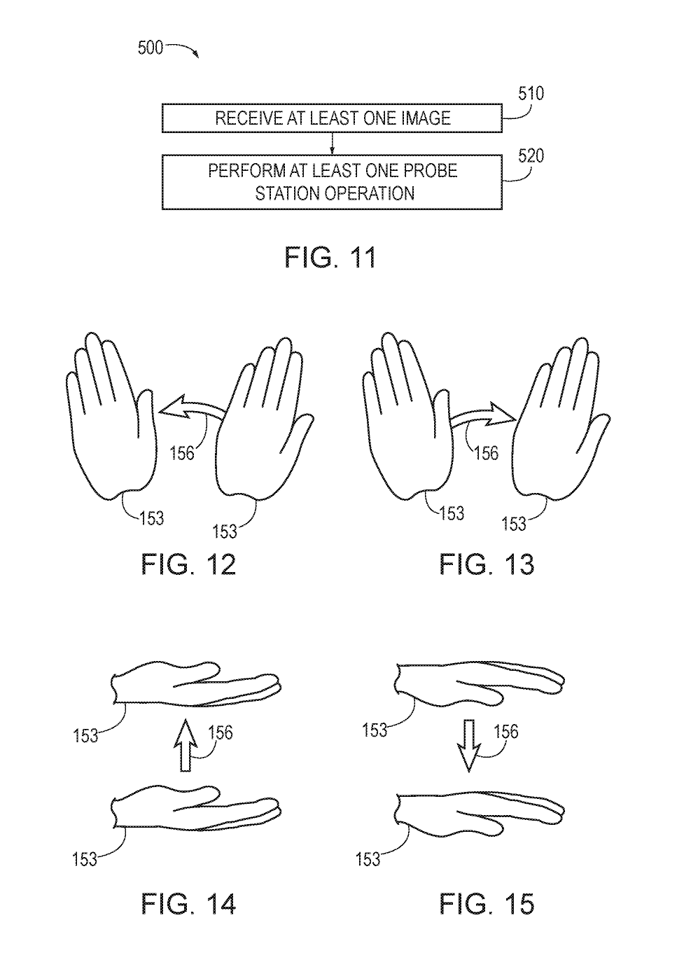

FIG. 11 is a flowchart depicting a method 500, according to the present disclosure, of controlling the operation of a probe station, such as probe station 100 of FIG. 1, while FIGS. 12-15 provide examples of gestures that may be utilized with the method of FIG. 11. The probe station may be configured to test the operation of a device under test (DUT), such as DUT 192 of FIG. 1, that is formed on a substrate, such as substrate 190 of FIG. 1. Methods 500 include receiving at least one image at 510 and performing at least one probe station operation at 520.

Receiving the at least one image at 510 may include receiving, with a user-imaging device of the probe station, at least one image of a gesture from a user. The at least one image may include a single image of the gesture, a series of images of the gesture, a chronological series of images of the gesture, and/or a video, or video sequence, of the gesture.

Performing the at least one probe station operation at 520 may include performing any suitable probe station operation based, at least in part, on the gesture from the user, on the at least one image of the gesture from the user, and/or on the receiving at 510. As an example, the receiving at 510 may include receiving a gesture of a hand swipe, or motion, to the left. This is illustrated in FIG. 12 by the motion of a user's hand 153, along arrow 156, to the left and/or from the right to the left. Under these conditions, the performing at 520 may include stepping, or transitioning, with the probe station, from a current test site of the DUT to a subsequent test site on the substrate and/or of the DUT.

As another example, the receiving at 510 may include receiving a gesture of a hand swipe, or motion, to the right. This is illustrated in FIG. 13 by motion of user's hand 153, along arrow 156, to the right and/or from the left to the right. Under these conditions, the performing at 520 may include stepping, or transitioning, with the probe station, from the current test site to a previous test site on the substrate and/or of the DUT.

As yet another example, the receiving at 510 may include receiving a gesture of an upward hand motion with a palm of the hand facing upward. This is illustrated in FIG. 14 by the motion of user's hand 153, with palm up and along arrow 156, in an upward direction. Under these conditions, the performing at 520 may include translating a plurality of probes of the probe station and the substrate toward one another.

As another example, the receiving at 510 may include receiving a gesture of a downward hand motion with the palm of the hand facing downward. This is illustrated in FIG. 15 by the motion of user's hand 153, with palm down and along arrow 156, in a downward direction. Under these conditions, the performing at 520 may include translating the plurality of probes and the substrate away from one another.

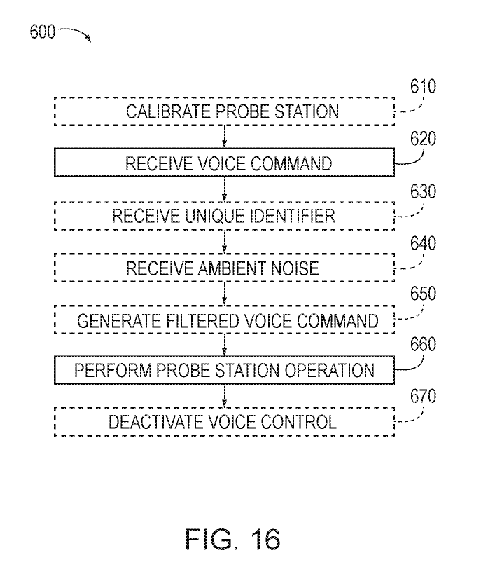

FIG. 16 is a flowchart depicting methods 600, according to the present disclosure, of controlling the operation of a probe station, such as probe station 100 of FIG. 1. The probe station may be configured to test the operation of a device under test (DUT), such as DUT 192 of FIG. 1, that is formed on a substrate, such as substrate 190 of FIG. 1.

Methods 600 may include calibrating the probe station at 610, and methods 600 include receiving a voice command at 620. Methods 600 also may include receiving a unique identifier at 630, receiving ambient noise at 640, and/or generating a filtered voice command at 650. Methods 600 include performing a probe station operation at 660 and may include deactivating voice controls at 670.

Calibrating the probe station at 610 may include calibrating the probe station to a specific, pre-established, and/or designated voice of a specific, pre-established, and/or designated user of the probe station. The calibrating at 610 may include calibrating in any suitable manner. As an example, the calibrating at 610 may include receiving one or more calibration voice commands from the designated user, such as to establish and/or confirm voice recognition for the designated user.

Receiving the voice command at 620 may include receiving the voice command from a user, or from the designated user, with a microphone of the probe station. Examples of the voice command may include one or more of a voice command to move a stage of the probe station to a home position, to move the stage of the probe station to a load position, to move the stage of the probe station to a center position, and/or to move the stage of the probe station to a contact position. Additional examples of the voice command may include one or more of a voice command to contact a plurality of probes of the probe station with the DUT and/or to separate the plurality of probes from the DUT. Additional examples of the voice command may include one or more of a voice command to turn on a viewing light, to turn off a viewing light, to step from a current test site to a subsequent test site, to step from the current test site to a previous test site, to identify, for the user, which DUT in a plurality of DUTs currently is being tested by the probe station, to identify, for the user, a temperature of the probe station, and/or to test, or initiate testing of, the DUT.

Receiving the unique identifier at 630 may include receiving any suitable unique identifier, from the user and via the microphone, that uniquely identifies the probe station. As an example, the probe station may be a selected probe station of a plurality of probe stations within a measurement environment. Under these conditions, each probe station in the plurality of probe stations may have a predetermined unique identifier associated therewith; and methods 600 may include performing the at least one probe station operation on the selected probe station, at 660, when, or only when, the unique identifier, which is associated with the selected probe station, is received during the receiving at 630.

Receiving ambient noise at 640 may include receiving ambient noise proximate the user. As an example, the microphone may be a first microphone, which may face toward the user, and the probe system further may include a second microphone, which may face away from the user. Under these conditions, the first microphone may be utilized during the receiving at 620 and/or during the receiving at 630; and the second microphone may be utilized during the receiving at 640. Examples of the first microphone and/or of the second microphone are disclosed herein.

When methods 600 include the receiving at 640, methods 600 also may include generating the filtered voice command at 650. The generating at 650 may include generating the filtered voice command based, at least in part, on the voice command from the user, as received during the receiving at 620, and the ambient noise, as received during the receiving at 640. Stated another way, the generating at 650 may include utilizing the voice command, as received by the first microphone, and the ambient noise, as received from the second microphone, to generate a filtered voice command in which the ambient noise has been cancelled, in which the ambient noise has been at least substantially cancelled, and/or in which a signal to noise ratio for the voice command is greater than that obtained during the receiving at 620.

Performing the probe station operation at 660 may include performing at least one probe station operation based, at least in part, on the voice command as received during the receiving at 620 and/or on the filtered voice command as generated during the generating at 650. The probe station may be configured to perform a plurality of probe station operations, and each of the plurality of probe station operations may be correlated to a specific, or distinct, voice command of a plurality of voice commands. Examples of the plurality of voice commands are disclosed herein with reference to the receiving at 620.

Responsive to receipt of a specific one of the plurality of voice commands, the probe station automatically may execute the performing at 660, such as to perform at least one corresponding probe station operation. Examples of the at least one probe station operation include moving a stage of the probe station to a home position, to a load position, to a center position, and/or to a contact position. Additional examples of the at least one probe station operation include contacting a plurality of probes of the probe station with the DUT and/or separating the plurality of probes from the DUT. Additional examples of the at least one probe station operation include turning on a viewing light, turning off the viewing light, stepping from a current test site to a subsequent test site, stepping from the current test site to a previous test site, identifying, for the user, which DUT currently is being tested by the probe station, identifying, for the user, a temperature of the probe station, and/or testing the DUT.

Deactivating voice controls at 670 may include deactivating voice controls during the performing at 660. As an example, the performing at 660 may include performing an automated, or automatic, measurement routine with the probe station. Under these conditions, it may be undesirable for the probe station to perform additional, or different, probe station operations until after completion of the automated measurement routine. Thus, the deactivating at 670 may include deactivating the microphone and/or ignoring a subsequent voice command, from the user, that is received during the automated measurement routine. Stated another way, the deactivating at 670 may include completing the automated measurement routine prior to receiving, accepting, and/or executing a subsequent voice command from the user.

Methods 200, 300, and 400, which are disclosed herein, are disclosed as receiving input regarding a specified number of fingers, on one or more of the user's hand(s), contacting and/or translating across the touch screen display. More specifically, methods 200 include receiving, at 230, information regarding motion of two of the user's fingers across the touch screen display, methods 300 include receiving, at 330, information regarding motion of three of the user's fingers across the touch screen display, and methods 400 include receiving, at 430, information regarding relative rotation, on the touch screen display, between two fingers of one of the user's hands and two fingers of the other of the user's hands. While these methods are disclosed herein as utilizing the specified number of fingers, or contact points, to contact and/or move across the touch screen display, it is within the scope of the present disclosure that another, or a different, number of fingers may be utilized. As examples, methods 200, 300, and/or 400 may utilize contact between one, two, three, four, or all five fingers on a given hand and the touch screen display without departing from the scope of the present disclosure.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

Illustrative, non-exclusive examples of probe systems, probe stations, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A method of controlling the operation of a probe station, wherein the probe station is configured to test the operation of a device under test (DUT) that is formed on a substrate, the method comprising:

displaying, with a touch screen display, a first image of the probe station collected by an imaging device of the probe station;

receiving, with the touch screen display, a user input from a user, wherein the user input includes information regarding:

(i) contact between two of the user's fingers and the touch screen display; and

(ii) motion, while in contact with the touch screen display, of the two of the user's fingers across the touch screen display;

displaying, with the touch screen display, a second image of the probe station collected by the imaging device, wherein:

(i) a structure is displayed in both the first image of the probe station and the second image of the probe station; and

(ii) a difference between a first location of the structure in the first image of the probe station and a second location of the structure in the second image of the probe station is based, at least in part, on the receiving;

wherein the displaying the second image of the probe station includes at least one of:

(i) changing a relative orientation between the imaging device and at least one other component of the probe station;

(ii) panning the imaging device between the first image and the second image; and

(iii) continuously displaying a series of images that illustrate motion of the structure between the first location and the second location.

A2. The method of paragraph A1, wherein both the first image of the probe station and the second image of the probe station include, and optionally are, images that include at least one of:

(i) at least a portion of the substrate;

(ii) at least a portion of the DUT; and

(iii) at least one probe tip configured to contact a corresponding contact pad of the DUT.

A3. The method of any of paragraphs A1-A2, wherein the receiving includes:

(i) determining an initial contact location between the two of the user's fingers and the touch screen display;

(ii) determining a subsequent contact location between the two of the user's fingers and the touch screen display; and

(iii) determining a distance between the initial contact location and the subsequent contact location.

A4. The method of paragraph A3, wherein the difference between the first location of the structure and the second location of the structure is based, at least in part, on the distance between the initial contact location and the subsequent contact location.

A5. The method of any of paragraphs A3-A4, wherein a direction, on the touch screen display, from the first location of the structure to the second location of the structure is based, at least in part, on a direction between the initial contact location and the subsequent contact location.

A6. The method of any of paragraphs A3-A5, wherein a vector that extends, on the touch screen display, from the first location of the structure to the second location of the structure is based, at least in part, or is, a vector that extends, on the touch screen display, from the initial contact location to the subsequent contact location.

A7. The method of any of paragraphs A1-A6, wherein:

(i) the first location of the structure corresponds to, and optionally is, a/the initial contact location between the two of the user's fingers and the touch screen display; and

(ii) the second location of the structure corresponds to, and optionally is, a/the subsequent contact location between the two of the user's fingers and the touch screen display.

A8. The method of any of paragraphs A1-A7, wherein the method further includes collecting the first image of the probe station with the imaging device and collecting the second image of the probe station with the imaging device.

A9. The method of any of paragraphs A1-A8, wherein the changing the relative orientation includes at least one of:

(i) moving the imaging device relative to the substrate; and

(ii) moving the substrate relative to the imaging device.

A10. The method of any of paragraphs A1-A9, wherein the structure is a first structure, wherein a second structure also is displayed in both the first image of the probe station and the second image of the probe station, and further wherein at least one of:

(i) a difference between a first location of the second structure in the first image of the probe station and a second location of the second structure in the second image of the probe station is based, at least in part, on the receiving; and

(ii) a distance between the first location of the second structure and the second location of the second structure is equal, or at least substantially equal, to a distance between the first location of the first structure and the second location of the first structure.

B1. A method of controlling the operation of a probe station, wherein the probe station is configured to test the operation of a device under test (DUT) that is formed on a substrate, the method comprising:

displaying, with a touch screen display, an initial view of the probe station generated by an initial imaging device;

receiving, with the touch screen display, a user input from a user, wherein the user input includes information regarding:

(i) contact between three of the user's fingers and the touch screen display; and

(ii) motion, while in contact with the touch screen display, of the three of the user's fingers across the touch screen display; and

responsive to the receiving, displaying, with the touch screen display, a subsequent view of the probe station generated by a subsequent imaging device that is different from the initial imaging device.

B2. The method of paragraph B1, wherein the touch screen display defines a characteristic dimension, and further wherein the displaying the subsequent view is responsive to the user input including information regarding motion of the three of the user's fingers across at least a threshold fraction of the characteristic dimension.

B3. The method of paragraph B2, wherein the characteristic dimension includes at least one of a width of the touch screen display and a height of the touch screen display.

B4. The method of any of paragraphs B2-B3, wherein the threshold fraction of the characteristic dimension is at least one of at least 10%, at least 20%, at least 30%, at least 40%, at least 50%, at least 60%, at least 70%, at least 80%, at least 90%, at most 99%, at most 95%, at most 90%, at most 80%, at most 70%, and at most 60% of the characteristic dimension.

B5. The method of any of paragraphs B1-B4, wherein at least one of the initial view and the subsequent view includes at least one of:

(i) a downward-looking view of the substrate;

(ii) a downward-looking view of at least one probe configured to contact a corresponding contact pad of the DUT;

(iii) a side view of the substrate;

(iv) a side view of the at least one probe;

(v) an upward-looking view of the substrate;

(vi) an upward-looking view of the at least one probe; and

(vii) an upward-looking view of a measurement device.

B6. The method of any of paragraphs B1-B5, wherein the method further includes:

repeating the receiving; and

transitioning through a plurality of available views of the probe station, wherein the transitioning includes advancing from a given view in the plurality of available views to a next view in the plurality of available views responsive to each instance of the repeating.

C1. A method of controlling the operation of a probe station, wherein the probe station is configured to test the operation of a device under test (DUT) that is formed on a substrate, the method comprising:

displaying, with a touch screen display, an initial image of the probe station;

receiving, with the touch screen display, a user input from a user, wherein the user input includes information regarding:

(i) contact between two fingers on a first hand of the user and the touch screen display;

(ii) contact between two fingers on a second hand of the user and the touch screen display; and

(iii) rotational motion, while in contact with the touch screen display, of at least one of:
a) the two fingers on the first hand relative to the two fingers on the second hand;
b) the two fingers on the second hand relative to the two fingers on the first hand; and
c) the two fingers on the first hand and the two fingers on the second hand relative to one another; and

displaying, with the touch screen display, a rotated image of the probe station, wherein a difference between the initial image of the probe station and the rotated image of the probe station is based, at least in part, on the receiving.

C2. The method of paragraph C1, wherein the initial image of the probe station and the rotated image of the probe station include, and optionally are, images that include at least one of:

(i) at least a portion of the substrate;

(ii) at least a portion of the DUT; and

(iii) at least one probe tip configured to contact a corresponding contact pad of the DUT.

C3. The method of any of paragraphs C1-C2, wherein the displaying the rotated image includes rotating the initial image of the probe station about an axis of rotation to generate the rotated image of the probe station.

C4. The method of any of paragraphs C1-C3, wherein the method further includes collecting the initial image of the probe station with an imaging device and collecting the rotated image of the probe station with the imaging device, and further wherein the displaying the rotated image of the probe station includes changing a relative orientation between the imaging device and at least one other component of the probe station.

C5. The method of paragraph C4, wherein the changing the relative orientation includes at least one of:

(i) rotating the imaging device relative to the substrate; and

(ii) rotating the substrate relative to the imaging device.

C6. The method of any of paragraphs C4-05, wherein the changing the relative orientation includes rotationally aligning a plurality of probes of the probe station with a plurality of corresponding contact pads of the DUT.

C7. The method of any of paragraphs C1-C6, wherein, subsequent to the displaying the initial image, prior to the displaying the rotated image, and concurrently with the receiving the user input, the method further includes displaying a plurality of intermediate images that illustrate a transition from the initial image to the rotated image, optionally wherein the displaying the plurality of intermediate images is synchronous with motion of the user's fingers during the receiving the user input.

D1. A method of controlling the operation of a probe station, wherein the probe station is configured to test the operation of a device under test (DUT) that is formed on a substrate, the method comprising:

receiving, with a user-imaging device of the probe station, at least one image of a gesture from a user; and

performing at least one probe station operation based, at least in part, on the gesture from the user.

D2. The method of paragraph D1, wherein the at least one image of the gesture from the user includes a series, and optionally a chronological series, of images of the gesture from the user.

D3. The method of any of paragraphs D1-D2, wherein at least one of:

(i) the gesture includes a hand swipe to the left and the at least one probe station operation includes stepping, with the probe station, from a current test site on the substrate and/or of the DUT to a subsequent test site on the substrate and/or of the DUT;

(ii) the gesture includes a hand swipe to the right and the at least one probe station operation includes stepping, with the probe station, from the current test site on the substrate and/or of the DUT to a previous test site on the substrate and/or of the DUT;

(iii) the gesture includes an upward hand motion with a palm of the hand facing upward and the at least one probe station operation includes translating a plurality of probes of the probe station and the substrate toward one another; and

(iv) the gesture includes a downward hand motion with the palm of the hand facing downward and the at least one probe station operation includes translating the plurality of probes and the substrate away from one another.

E1. A method of controlling the operation of a probe station, wherein the probe station is configured to test the operation of a device under test (DUT) that is formed on a substrate, the method comprising:

receiving, with a microphone of the probe station, a voice command from a user; and

performing at least one probe station operation based, at least in part, on the voice command from the user.

E2. The method of paragraph E1, wherein, prior to the receiving, the method further includes calibrating the probe station to a designated voice of a designated user.

E3. The method of any of paragraphs E1-E2, wherein the microphone is a first microphone configured to detect the voice command from the user, wherein the probe station further includes a second microphone configured to detect ambient noise proximate the user, and further wherein the method includes:

(i) receiving, with the second microphone, ambient noise from proximate the user; and

(ii) generating a filtered voice command based, at least in part, on the voice command from the user as received by the first microphone and also on the ambient noise from proximate the user as received by the second microphone, wherein the performing is based, at least in part, on the filtered voice command.

E4. The method of paragraph E3, wherein the first microphone faces toward the user and the second microphone faces away from the user.

E5. The method of any of paragraphs E1-E4, wherein the probe station is a selected probe station of a plurality of probe stations within a measurement environment, wherein the receiving further includes receiving a unique identifier from the user, and further wherein the method includes performing the at least one probe station operation only when the unique identifier is associated with the selected probe station.

E6. The method of any of paragraphs E1-E5, wherein the probe station is configured to perform an automated measurement routine, and further wherein, during the automated measurement routine, the method includes at least one of:

(i) deactivating the microphone; and

(ii) ignoring the voice command from the user.

E7. The method of any of paragraphs E1-E6, wherein the probe station is configured to perform a plurality of probe station operations.

E8. The method of paragraph E7, wherein each probe station operation in the plurality of probe station operations is correlated to a specific voice command of a plurality of voice commands.

E9. The method of paragraph E8, wherein the plurality of probe station operations includes at least one of:

(i) moving a stage of the probe station to a home position;

(ii) moving the stage of the probe station to a load position;

(iii) moving the stage of the probe station to a center position;

(iv) moving the stage of the probe station to a contact position;

(v) contacting a plurality of probes of the probe station with the DUT;

(vi) separating the plurality of probes of the probe station from the DUT;

(vii) turning a viewing light on;

(viii) turning a viewing light off;

(ix) stepping from a current test site to a subsequent test site;

(x) stepping from the current test site to a previous test site;

(xi) identifying, for the user, which DUT in a plurality of DUTs currently is being tested by the probe station;

(xii) identifying, for the user, a temperature of the probe station; and

(xiii) testing the DUT.

F1. A probe station configured to test the operation of a device under test (DUT) that is formed on a substrate, the probe station comprising:

a chuck defining a support surface configured to support the substrate;

a probe assembly including a plurality of probe tips configured to contact a corresponding plurality of contact pads on the DUT; and

a controller programmed to control the operation of the probe station according to the method of any of paragraphs A1-E9.

F2. The probe station of paragraph F1, wherein the probe station further includes at least one of:

(i) a/the touch screen display in communication with the controller;

(ii) an/the imaging device in communication with the controller and configured to collect an image of the probe station;

(iii) a plurality of spaced-apart imaging devices in communication with the controller and configured to collect a plurality of distinct images of the probe station;

(iv) a/the user-imaging device configured to collect an/the image of a/the gesture from the user;

(v) a/the, or a/the first, microphone configured to receive a/the voice command from a/the user; and

(vi) a/the second microphone configured to detect ambient noise proximate the user.

F3. The probe station of any of paragraphs F1-F2, wherein the chuck includes at least one of:

(i) a chuck thermal module configured to control a temperature of the chuck;

(ii) a chuck translation structure in communication with the controller configured to operatively translate the support surface relative to the probe assembly; and

(iii) a chuck rotation structure in communication with the controller and configured to operatively rotate the support surface relative to the probe assembly.

F4. Non-transitory computer-readable storage media including computer-readable instructions that, when executed, direct a probe station to perform the method of any of paragraphs A1-E9.

G1. A probe system configured to test the operation of a device under test (DUT) that is formed on a substrate, the probe system comprising:

a probe station including any suitable structure of any of the probe stations of any of paragraphs F1-F3;

a server in communication with the probe station; and

a mobile device in communication with the probe station via the server.

G2. The probe system of paragraph G1, wherein the mobile device is programmed to at least one of:

(i) transmit, via the server, a status update request to the probe station;

(ii) receive, via the server, the status update from the probe station;

(iii) receive, via the server, an error indication from the probe station;

(iv) transmit, via the server, a command signal to the probe station.

G3. The probe system of any of paragraphs G1-G2, wherein the probe system includes a plurality of probe stations in communication with the server.

G4. The probe system of paragraph G3, wherein the mobile device is in communication with the plurality of probe stations via the server.

G5. The probe system of any of paragraphs G1-G4, wherein the mobile device includes at least one of a handheld device, a wireless device, a cellular device, a cellular phone, a tablet, and a laptop computer.

### INDUSTRIAL APPLICABILITY

The probe stations, probe systems, and methods disclosed herein are applicable to the semiconductor manufacturing and test industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of controlling the operation of a probe station, wherein the probe station is configured to test the operation of a device under test (DUT) that is formed on a substrate, the method comprising:
displaying, with a touch screen display, a first image of the probe station collected by an imaging device of the probe station;
receiving, with the touch screen display, a user input from a user, wherein the user input includes information regarding:
(i) contact between two of the user's fingers and the touch screen display; and
(ii) motion, while in contact with the touch screen display, of the two of the user's fingers across the touch screen display;
displaying, with the touch screen display, a second image of the probe station collected by the imaging device, wherein:
(i) a structure is displayed in both the first image of the probe station and the second image of the probe station; and
(ii) a difference between a first location of the structure in the first image of the probe station and a second location of the structure in the second image of the probe station is based, at least in part, on the receiving;
wherein the displaying the second image of the probe station includes at least one of:
(i) changing a relative orientation between the imaging device and at least one other component of the probe station;
(ii) panning the imaging device between the first image and the second image; and
(iii) continuously displaying a series of images that illustrate motion of the structure between the first location and the second location.

2. The method of claim 1, wherein both the first image of the probe station and the second image of the probe station are images that include at least one of:
(i) at least a portion of the substrate;
(ii) at least a portion of the DUT; and
(iii) at least one probe tip configured to contact a corresponding contact pad of the DUT.

3. The method of claim 1, wherein the receiving includes:
(i) determining an initial contact location between the two of the user's fingers and the touch screen display;
(ii) determining a subsequent contact location between the two of the user's fingers and the touch screen display; and
(iii) determining a distance between the initial contact location and the subsequent contact location.

4. The method of claim 3, wherein the difference between the first location of the structure and the second location of the structure is based, at least in part, on the distance between the initial contact location and the subsequent contact location.

5. The method of claim 3, wherein a direction, on the touch screen display, from the first location of the structure to the second location of the structure is based, at least in part, on a direction between the initial contact location and the subsequent contact location.

6. The method of claim 3, wherein a vector that extends, on the touch screen display, from the first location of the structure to the second location of the structure is based, at least in part, on a vector that extends, on the touch screen display, from the initial contact location to the subsequent contact location.

7. The method of claim 1, wherein:
(i) the first location of the structure corresponds to an initial contact location between the two of the user's fingers and the touch screen display; and
(ii) the second location of the structure corresponds to a subsequent contact location between the two of the user's fingers and the touch screen display.

8. The method of claim 1, wherein the method further includes collecting the first image of the probe station with the imaging device and collecting the second image of the probe station with the imaging device.

9. The method of claim 1, wherein the changing the relative orientation includes at least one of:
(i) moving the imaging device relative to the substrate; and
(ii) moving the substrate relative to the imaging device.

10. The method of claim 1, wherein the structure is a first structure, wherein a second structure also is displayed in both the first image of the probe station and the second image of the probe station, and further wherein at least one of:
(i) a difference between a first location of the second structure in the first image of the probe station and a second location of the second structure in the second image of the probe station is based, at least in part, on the receiving; and
(ii) a distance between the first location of the second structure and the second location of the second structure is at least substantially equal to a distance between the first location of the first structure and the second location of the first structure.

11. A probe station configured to test the operation of a device under test (DUT) that is formed on a substrate, the probe station comprising:
a chuck defining a support surface configured to support the substrate;
a probe assembly including a plurality of probe tips configured to contact a corresponding plurality of contact pads on the DUT; and
a controller programmed to control the operation of the probe station according to the method of claim 1.

12. The probe station of claim 11, wherein the probe station further includes at least one of:
(i) the touch screen display in communication with the controller; and
(ii) the imaging device in communication with the controller and configured to collect the first image and the second image.

13. A probe system configured to test the operation of a device under test (DUT) that is formed on a substrate, the probe system comprising:
the probe station of claim 11;
a server in communication with the probe station; and
a mobile device in communication with the probe station via the server.

14. The probe system of claim 13, wherein the mobile device is programmed to at least one of:
(i) transmit, via the server, a status update request to the probe station;
(ii) receive, via the server, the status update from the probe station;
(iii) receive, via the server, an error indication from the probe station;
(iv) transmit, via the server, a command signal to the probe station.

15. The probe system of claim 13, wherein the probe system includes a plurality of probe stations in communication with the server.

16. The probe system of claim 15, wherein the mobile device is in communication with the plurality of probe stations via the server.

17. The probe system of claim 13, wherein the mobile device includes at least one of a handheld device, a wireless device, a cellular device, a cellular phone, a tablet, and a laptop computer.

18. Non-transitory computer-readable storage media including computer-readable instructions that, when executed, direct a probe station to perform the method of claim 1.

19. A method of controlling the operation of a probe station, wherein the probe station is configured to test the operation of a device under test (DUT) that is formed on a substrate, the method comprising:
displaying, with a touch screen display, an initial view of the probe station generated by an initial imaging device;
receiving, with the touch screen display, a user input from a user, wherein the user input includes information regarding:
(i) contact between three of the user's fingers and the touch screen display; and
(ii) motion, while in contact with the touch screen display, of the three of the user's fingers across the touch screen display; and
responsive to the receiving, displaying, with the touch screen display, a subsequent view of the probe station generated by a subsequent imaging device that is different from the initial imaging device.

20. A method of controlling the operation of a probe station, wherein the probe station is configured to test the operation of a device under test (DUT) that is formed on a substrate, the method comprising:
displaying, with a touch screen display, an initial image of the probe station;
receiving, with the touch screen display, a user input from a user, wherein the user input includes information regarding:
(i) contact between two fingers on a first hand of the user and the touch screen display;
(ii) contact between two fingers on a second hand of the user and the touch screen display; and
(iii) rotational motion, while in contact with the touch screen display, of at least one of:
a) the two fingers on the first hand relative to the two fingers on the second hand;
b) the two fingers on the second hand relative to the two fingers on the first hand; and
c) the two fingers on the first hand and the two fingers on the second hand relative to one another; and
displaying, with the touch screen display, a rotated image of the probe station, wherein a difference between the initial image of the probe station and the rotated image of the probe station is based, at least in part, on the receiving.
